(19) United States
(12) Patent Application Publication
(10) Pub. No.: US 2024/0424769 A1
(43) Pub. Date: Dec. 26, 2024

(54) ROLL MATERIAL FOR MAKING ANTI-COUNTERFEITING SEALING FILM AND SEALING FILM

(71) Applicant: HI-JOINT TECHNOLOGIES CORPORATION, New Taipei City (TW)

(72) Inventor: YEN-WU YANG, New Taipei City (TW)

(21) Appl. No.: 18/338,366

(22) Filed: Jun. 21, 2023

(51) Int. Cl. B32B 27/08; B32B 3/26; B32B 7/14; B32B 27/16; B32B 27/32; B32B 27/36; B65D 65/40

(52) U.S. Cl. CPC B32B 27/08; B32B 3/266; B32B 7/14; B32B 27/16; B32B 27/32; B32B 27/36; B65D 65/40; B32B 2250/04; B32B 2250/24; B32B 2255/10; B32B 2255/24; B32B 2255/26; B32B 2307/31; B32B 2307/406; B32B 2307/408; B32B 2435/02

(57) ABSTRACT

A roll material comprises an adhesive sealing film, and a lifting and pulling composite layer, located on the adhesive sealing film. The lifting and pulling composite layer includes an information layer, a backing layer, and a layer of functional film sequentially from top to bottom. The layer of functional film has a PE film or an EPE film and a plurality of microbonding blocks sequentially from top to bottom, and the plurality of microbonding blocks is coated with a release coating. The roll material can be made into an anti-counterfeiting sealing film, which has a good re-sealing effect and anti-counterfeiting effect.

### BACKGROUND OF THE INVENTION

### 1. Field of the Invention

The present disclosure relates to a roll material, and more particularly to a roll material for making an anti-counterfeiting sealing film.

### 2. Description of the Related Art

With the continuous progress of society, people have higher requirements for the packaging and sealing of containers of bubble tea, coffee, beverages, etc., not only in considering the convenience, hygiene, and safety of opening the sealing, but also in considering the shelf life after re-sealing. For example, it has been proposed to use sealing films as packaging and sealing of containers.

In addition, in order to realize the traceability of products, information tags (which are generally radio frequency tags) with information reading and writing functions will be set on the packaging of products, and product information, such as product models, production history, logistics and transportation data, and other product information will be written in the information labels. For example, it has been proposed to attach information labels directly to the outside of the container of the product.

### BRIEF SUMMARY OF THE INVENTION

However, in the case of the traditional sealing film, users often use a tool to stab, a knife to cut or tear the sealing film, resulting in unhygienic and unsafe opening of packaging and sealing. In addition, after the traditional sealing film is torn, it cannot be effectively resealed and stored, which will shorten the shelf life of the unused contents in the container and be prone to deterioration and spoilage.

In addition, because the prior art adheres the information label directly to the outside of the product container, it will make it easy for users to tear off the information label and use it for secondary use. What is more, some users will tear off the information label and re-affix it to the container of other products for secondary use, resulting in poor anti-counterfeiting of the information label.

Therefore, how to solve the problem that the sealing film cannot be effectively resealed after tearing, making the unused contents in the container difficult to preserve, and the anti-counterfeiting problem of the information label, has become an issue that the technical field of sealing film is eager to solve.

The present disclosure provides a roll material that can be used to make an anti-counterfeiting sealing film (hereinafter referred to as sealing film). Specifically, after the anti-counterfeiting sealing film of containers made of the roll material of the present disclosure is heat sealed, the sealing film can be torn along the tearing line designed according to the product or customer needs, and the sealing film is easy to tear into various sizes of openings through which powder, granules, blocks, or liquid items can be filled into the container, and a straw can also be easily inserted. Even if a paper straw is used, there is no need to worry about the straw being damaged during the insertion process.

Next, after the sealing film is torn, a circle of adhesive sealing film and lifting and pulling composite layer (which can be used as a sealing film for re-sealing) is still adhered to an upper surface of the container's mouth edge, and after tightening the container lid, it has a good re-sealing effect. Moreover, in order to prevent some users from tearing off the information label and re-affixing it on the container of other products for secondary use, the information layer in the lifting and pulling composite layer is also torn off or torn apart at the same time, resulting in the information layer being completely unreadable or not easy to read, so as to have a good anti-counterfeiting effect.

In order to solve the above problems and more, an aspect of a roll material for making an anti-counterfeiting sealing film of the present disclosure includes an adhesive sealing film and a lifting and pulling composite layer, located on the adhesive sealing film. The lifting and pulling composite layer includes an information layer, a backing layer, and a layer of functional film sequentially from top to bottom. The layer of functional film has a PE film or an EPE film and a plurality of microbonding blocks sequentially from top to bottom, and the plurality of microbonding blocks is coated with a release coating.

In an embodiment, the lifting and pulling composite layer has a tearing line that is formed through a continuous curve segment in coordination with a discontinuous curve segment.

In an embodiment, the PE film or the EPE film further includes a PET film thereon.

In an embodiment, a material of the release coating is epoxy, silicone oil, varnish, or wax.

In an embodiment, a surface of the release coating is glossy, matte, or dot matrix.

In an embodiment, a main base material of the adhesive sealing film is ethylene-vinyl acetate copolymer (EVA), polyethylene (PE), polypropylene (PP), or polyethylene terephthalate (PET).

In an embodiment, the information layer includes a base film, an information chip and an antenna layer sequentially from top to bottom.

In an embodiment, the information chip is a radio frequency identification (RFID) chip, near-field communication (NFC) chip, electromagnetic identification (EMID) chip, long range identification (LoRaID) chip, or ultra-wideband identification (UWBID) chip.

In an embodiment, a material of the base film is PET.

In an embodiment, the backing layer includes a PET film and a PE thick film sequentially from top to bottom.

In an embodiment, a dry composite adhesive is disposed between each of the adhesive sealing film, the information layer, the backing layer, and the layer of functional film.

An embodiment of an anti-counterfeiting sealing film of the present disclosure includes the roll material.

In an embodiment, the anti-counterfeiting sealing film has a tearing line, and a plurality of breakpoints is formed on a path of the tearing line.

An embodiment of the present disclosure provides a roll material (hereinafter referred to as the roll material) for making an anti-counterfeiting sealing film. The aforementioned roll material can be made into an anti-counterfeiting sealing film, which has a good re-sealing effect and anti-counterfeiting effect.

### BRIEF DESCRIPTION OF THE DRAWINGS

FIG. 1 is a schematic view of a roll material according to an embodiment of the present disclosure.

FIG. 2 is a schematic view of a layer of functional film according to an embodiment of the present disclosure.

FIG. 3 is a schematic view of a backing layer according to an embodiment of the present disclosure.

FIG. 4 is a schematic view of an information layer according to an embodiment of the present disclosure.

FIG. 5 is a schematic view of the layer of functional film according to an embodiment of the present disclosure.

FIG. 6 is a schematic view of the roll material according to an embodiment of the present disclosure.

FIG. 7 is a schematic view of an anti-counterfeiting sealing film according to an embodiment of the present disclosure.

### DETAILED DESCRIPTION OF THE INVENTION

The implementation of the present disclosure is illustrated by the specific embodiments as follows, so one skilled in the art may understand other advantages and effects of the present disclosure by the contents disclosed in the specification.

The present disclosure may also be implemented or applied by other embodiments, and the details in the specification may also be modified and varied based on different views and applications without departing from the spirit of the present disclosure.

Unless otherwise specified herein, the term “A-B” used in the specification and the claims attached includes the meaning of “A or more and B or less”. For example, the term “10-40 wt %” includes the meaning of “10 wt % or more and 40 wt % or less”.

### <Roll Material>

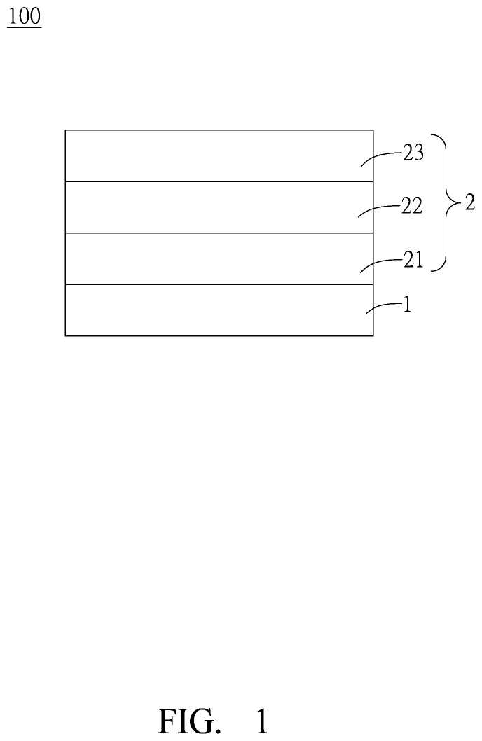

Refer to FIG. 1, which is a schematic view of a roll material of an embodiment of the present disclosure. As shown in FIG. 1, the roll material 100 of an embodiment of the present disclosure includes an adhesive sealing film 1 and a lifting and pulling composite layer 2 located on the adhesive sealing film 1.

### <Adhesive Sealing Film>

As shown in FIG. 1, the adhesive sealing film 1 is located at the bottom of the roll material 100. Herein, the adhesive sealing film 1 is placed at the bottom, so that when the roll material 100 is processed into a sealing film and heat sealed, the sealing film can be sealed at a mouth of a container.

In an embodiment, a main base material of the adhesive sealing film 1 may be ethylene-vinyl acetate copolymer (EVA), polyethylene (PE), polypropylene (PP), or polyethylene terephthalate (PET). Further, a thickness of the adhesive sealing film 1 may be 12-60 μm.

### <Lifting and Pulling Composite Layer>

As shown in FIG. 1, the lifting and pulling composite layer 2 includes an information layer 23, a backing layer 22, and a layer of functional film 21 sequentially from top to bottom. Each layer is described in detail below.

### <<Layer of Functional Film>>

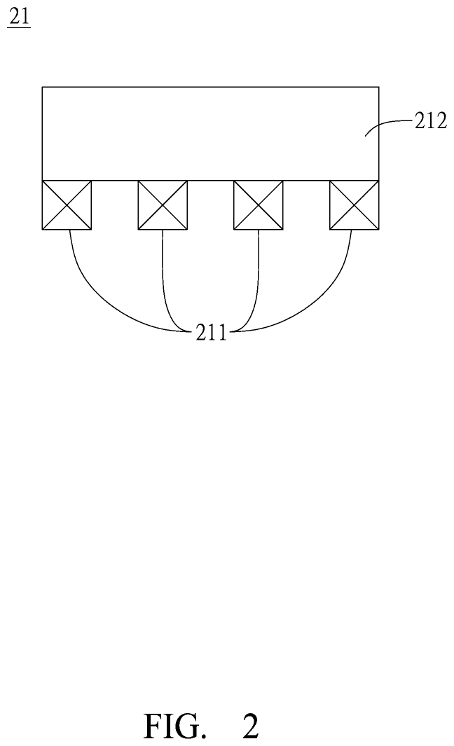

Refer to FIG. 2, which is a schematic view of a layer of functional film of an embodiment of the present disclosure. As shown in FIG. 2, the layer of functional film 21 has a PE film (or EPE film) 212 and a plurality of microbonding blocks 211 sequentially from top to bottom. A thickness of the PE film (or EPE film) 212 may be 30-150 μm, and a thickness of the plurality of microbonding blocks 211 may be 10-100 μm.

The plurality of microbonding blocks 211 is coated with a release coating, by which the microbonding blocks 211 can be given easy peelability, preventing the microbonding blocks 211 from strong adhesion to other layers. In order to give the microbonding blocks 211 preferable peelability, a material of the release coating may be epoxy, silicone oil, varnish, or wax, and a surface of the release coating is glossy, matte, or dot matrix.

The number of microbonding blocks 211 is the same as the number of lifting and pulling parts available for lifting and pulling, and the position of each of the microbonding blocks corresponds to the position of each of the lifting and pulling parts. The later-described lifting and pulling part, hollowed out part, and tearing line are designed and formed according to the product or customer's needs, so as to facilitate the user's fingers to pinch the lifting and pulling part and easily tear the sealing film. The hollowed out part allows the user to easily apply force to pinch the lifting and pulling part. Moreover, the tearing line is preferably a discontinuous segment, that is, a plurality of breakpoints is formed on a path of the tearing line, and the number of breakpoints is not particularly limited. Accordingly, the backing layer and the layer of functional film can be further firmly combined during processing to avoid material damage in each layer.

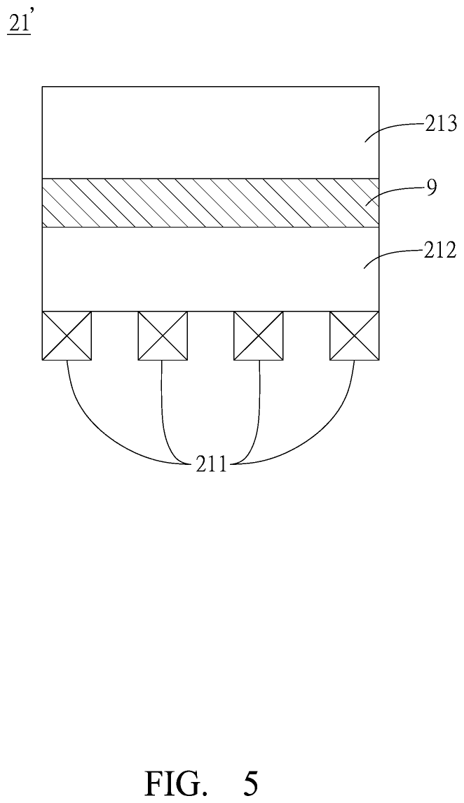

Refer to FIG. 5, which is a schematic view of the layer of functional film of an embodiment of the present disclosure. A PET film may be added to the layer of functional film depending on the situation, and the PET film is bonded with the PE film or EPE film by a dry composite adhesive. As shown in FIG. 5, the layer of functional film 21′ comprises a PET film 213, a dry composite adhesive 9, a PE film (or EPE film) 212, and a plurality of microbonding blocks 211 sequentially from top to bottom. The PE film (or EPE film) 212 and the microbonding blocks 211 are the same as those disclosed by the layer of functional film 21. A thickness of the PET film 213 may be 12-60 μm, and a thickness of the dry composite adhesive 9 may be 3-5 μm.

The layer of functional film 21 and/or the layer of functional film 21′ is placed below the backing layer 22, in order to strengthen the pinching force of the finger and fracture strength at lifting and pulling when the finger pinches the lifting and pulling part and tears the sealing film along the tear line after the sealing film made by processing is sealed.

### <<Backing Layer>>

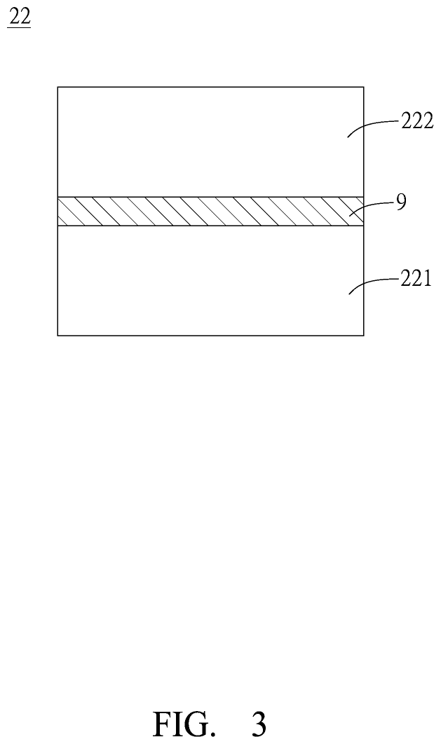

Refer to FIG. 3, which is a schematic view of a backing layer of an embodiment of the present disclosure. As shown in FIG. 3, the backing layer 22 has a PET film 222, a dry composite adhesive 9, and a PE thick film 221 sequentially from top to bottom. A thickness of the PET film 222 may be 12-60 μm, a thickness of the dry composite adhesive 9 may be 3-5 μm, and a thickness of the PE thick film 221 may be 60-200 μm.

The backing layer 22 is placed below the information layer 23, in order to protect an information chip and an antenna layer in the later-described information layer 23 by the cushioning effect of the backing layer 22.

### <<Information Layer>>

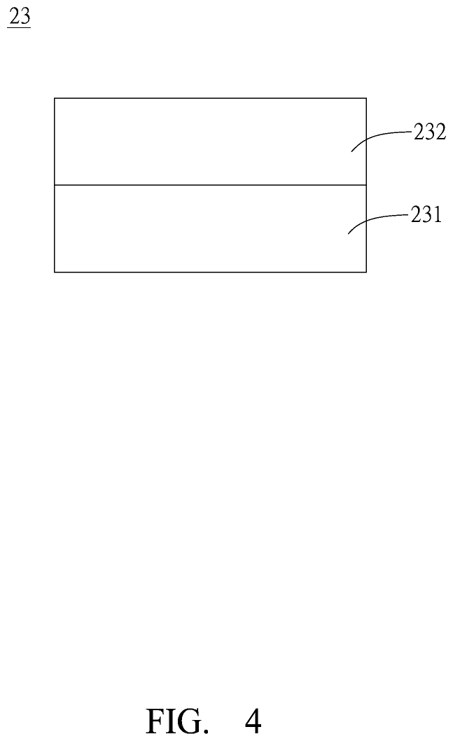

Refer to FIG. 4, which is a schematic view of an information layer of an embodiment of the present disclosure. As shown in FIG. 4, the information layer 23 has a base film 232 and an information chip and an antenna layer 231 sequentially from top to bottom. A thickness of the base film 232 may be 30-70 μm and a thickness of the information chip and the antenna layer 231 may be 50-200 μm.

A material of the base film 232 may be PET. Further, the information chip may be a RFID chip, NFC chip, EMID chip, LoRaID chip, or UWBID chip, and there are no special restrictions.

The information layer 23 is placed at the top of the lifting and pulling composite layer 2, so that after the sealing film is sealed, the printing pattern on the top surface of the sealing film has a looming high-tech tactile or visual sense of the antenna of the information layer.

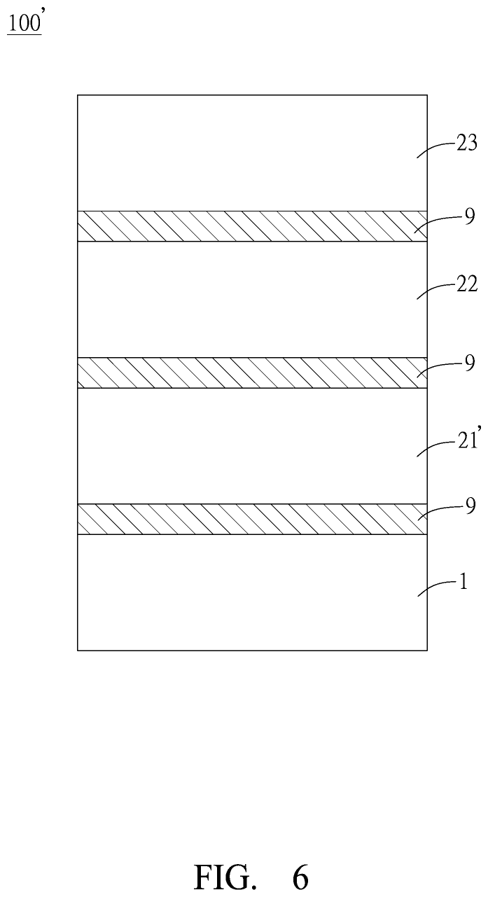

Refer to FIG. 6, which is a schematic view of the roll material of an embodiment of the present disclosure. As shown in FIG. 6, the roll material 100′ includes an information layer 23, a backing layer 22, a layer of functional film 21′, an aluminum foil 12, and an adhesive sealing film 1 sequentially from top to bottom. A dry composite adhesive 9 is disposed between each of the information layer 23, the backing layer 22, the layer of functional film 21′ and the adhesive sealing film 1. With the dry composite adhesive 9, the composite force between the above layers can be strengthened.

As for the details of the information layer 23, the backing layer 22, the layer of functional film 21′, the adhesive sealing film 1, and the dry composite adhesive 9 are concerned, the same contents as described in the foregoing embodiments will not be repeated herein.

### [Fabrication of Sealing Film]

Based on the following steps, the roll material 100′ of the aforementioned embodiment is made, and according to the size and shape of different products or customer needs, the aforementioned roll material 100′ is punched and cut by a punching die of a punching machine to obtain the sealing film for the customer's needs.

### (Fabrication of Adhesive Sealing Film)

One side of the adhesive sealing film (the main base material is EVA, PE, PP, or PET) is processed by corona treating to make a surface tension reach 40 dyne/cm or more, and this side is used as a to-be-compounded surface of the adhesive sealing film.

### (Fabrication of Backing Layer)

First, one side of the PET film is processed by corona treating, and this side is used as a to-be-compounded surface of the PET film. Next, one side of the PE thick film is processed by corona treating, and this side is used as a to-be-compounded surface of the PE thick film. Then, the to-be-compounded surface of the PET film is coated with the dry composite adhesive, passed through a drying channel at a rate of 20-120m/min (preferably set four stages of temperature in the drying tunnel: 58-62° C., 68-72° C., 73-77° C. and 78-82° C.), passed through heated composite rollers at a rate of 20-120m/min (the preferable temperature is 50-60° C.) to be bonded and compacted with the to-be-compounded surface of the PE thick film, and the backing layer is obtained after 48 hours of curing in the curing chamber. The corona treatment makes a surface tension of the to-be-compounded surface reach 40 dyne/cm or more.

### (Fabrication of Layer of Functional Film)

First, one side of the PET film is processed by corona treating, and this side is used as a to-be-compounded surface of the PET film. Next, one side of the PE film (or EPE film) is processed by corona treating, and this side is used as a to-be-compounded surface of the PE film (or EPE film). Then, the to-be-compounded surface of the PET film is coated with the dry composite adhesive, passed through a drying channel, passed through heated composite rollers, and then bonded and compacted with the to-be-compounded surface of the PE film (or EPE film), and a base material A of the layer of functional film is obtained after 48 hours of curing in the curing chamber. After that, the other side of the PET film in the base material A of the layer of functional film is processed by corona treating, and this side is used as a to-be-compounded surface of the base material A of the layer of functional film. The corona treatment makes a surface tension of the to-be-compounded surface reach dyne/cm or more, and the treatment conditions of passing through the drying channel and passing through the heated composite rollers are the same as those in the fabrication of the aforementioned backing layer.

The PET film and the dry composite adhesive may also be omitted, and a base material B of the layer of functional film only containing the PE film (or EPE film) with one side of corona treatment is obtained, and the side treated with corona treatment is used as a to-be-compounded surface.

### (Fabrication of Information Layer)

First, one side of the base film is processed by corona treating, and this side is used as a to-be-printed surface of the base film. Then, according to customer needs, the pattern of the information chip and the antenna layer is printed on the to-be-printed surface of the base film to obtain the information layer in the form of surface printing. Then, one side of the information chip and the antenna layer in the information layer is processed by corona treating, and this side is used as a to-be-compounded surface of the information layer. The corona treatment makes a surface tension of the to-be-printed surface reach 40 dyne/cm or more.

### (Compounding of Backing Layer and Information Layer)

First, the other side of the PET film in the backing layer is processed by corona treating, and this side is used as a to-be-compounded surface of the backing layer. Next, the to-be-compounded surface of the backing layer is coated with the dry composite adhesive, passed through a drying channel, passed through heated composite rollers, and then bonded and compacted with the to-be-compounded surface of the aforementioned printed information layer, and the backing layer plus the information layer is obtained after 48 hours of curing in the curing chamber. Next, one side of the PE thick film of the backing layer in the backing layer plus the information layer is processed by corona treating, and this side is used as a to-be-compounded surface of the backing layer plus the information layer. The corona treatment makes a surface tension of the to-be-compounded surface reach 40 dyne/cm or more, and the treatment conditions of passing through the drying channel and passing through the heated composite rollers are the same as those in the fabrication of the aforementioned backing layer.

### (Fabrication of Lifting and Pulling Composite Layer)

The to-be-compounded surface of the base material (A or B) of the layer of functional film is coated with the dry composite adhesive, passed through a drying channel, passed through heated composite rollers, and then bonded and compacted with the to-be-compounded surface of the backing layer plus the information layer, and a base material of the lifting and pulling composite layer is obtained after 48 hours of curing in the curing chamber. Next, one side of the PE film (or EPE film) of the layer of functional film in the base material of the lifting and pulling composite layer is processed by corona treating, and this side is used as a to-be-coated surface of the base material of the lifting and pulling composite layer. The corona treatment makes surface tensions of the to-be-compounded surface and the to-be-coated surface reach 40 dyne/cm or more, and the treatment conditions of passing through the drying channel and passing through the heated composite rollers are the same as those in the fabrication of the aforementioned backing layer.

Next, in order to meet the different needs of the lifting and pulling part, the tearing line and the hollowed out part, corresponding positions in the base material of the lifting and pulling composite layer of a plurality of lifting and pulling parts in the roll material are used as to-be-coated positions in the to-be-coated surface of the base material of the lifting and pulling composite layer. A plurality of microbonding blocks in the layer of functional film are formed after coating the release coating, and the lifting and pulling composite layer is obtained.

Then, the lifting and pulling composite layer is processed by a punching machine for positioning punching and cutting of the lifting and pulling part, the hollowed out part, and the tearing line to form a lifting and pulling part, a hollowed out part, and a tearing line that meet different needs. Further, in the lifting and pulling composite layer, the tearing line is formed through a continuous curve segment in coordination with a discontinuous curve segment.

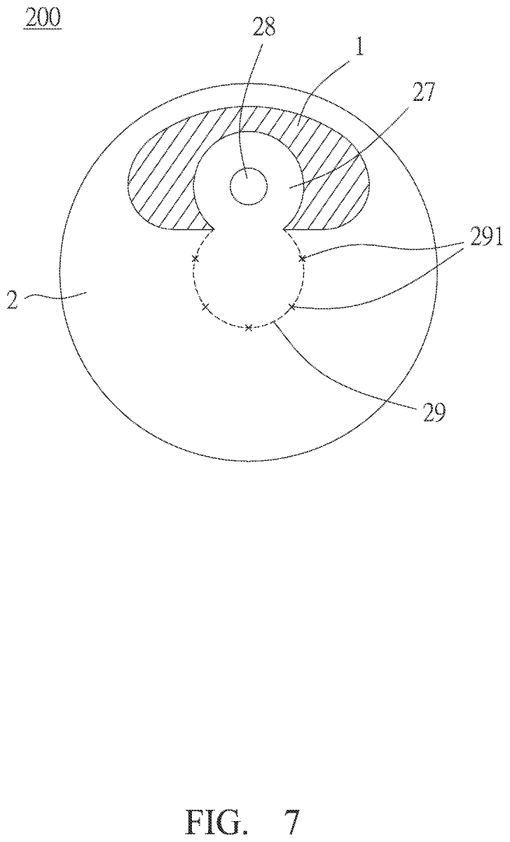

Refer to FIG. 7, which is a schematic view of an anti-counterfeiting sealing film 200 of an embodiment of the present disclosure. As shown in FIG. 7, the anti-counterfeiting sealing film 200 includes an adhesive sealing film 1 and a lifting and pulling composite layer 2 located thereon, and a lifting and pulling part 27, a hollowed out part 28, and a tearing line 29 with specific shapes are formed in the lifting and pulling composite layer 2. The hollowed out part 28 allows the user to easily apply force to pinch the lifting portion 27. Further, by using a mold with a discontinuous contour, the tearing line 29 formed with a plurality of breakpoints 291 on its path, and become a discontinuous segment. Further, in this embodiment, when the user tears the lifting and pulling composite layer 2 along the tearing line 29, a space for inserting a straw may be formed.

### (Fabrication of Roll Material)

First, one side of the PE film (or EPE film) of the layer of functional film in the lifting and pulling composite layer is processed by corona treating, and this side is used as a to-be-compounded surface of the lifting and pulling composite layer.

Then, the to-be-compounded surface of the lifting and pulling composite layer is coated with the dry composite adhesive, passed through a drying channel, passed through heated composite rollers, and then bonded and compacted with the to-be-compounded surface of the adhesive sealing film, and a roll material 100′ of an embodiment of the present disclosure is obtained after 48 hours of curing in the curing chamber. The aforementioned roll material 100′ can be made into an anti-counterfeiting sealing film, which has a good re-sealing effect and anti-counterfeiting effect. The corona treatment makes a surface tension of the to-be-compounded surface reach 40 dyne/cm or more, and the treatment conditions of passing through the drying channel and passing through the heated composite rollers are the same as those in the fabrication of the aforementioned backing layer.

It should be noted that the above description is only a specific example, and the sequence in which the above layers are fabricated is not particularly limited thereto. Further, although the fabrication of roll material 100′ is described herein, the layer of functional film 21 can also be used as an alternative to the layer of functional film 21′, and other compounding methods (bonding, joining, connecting, etc.) can be used as an alternative to the dry composite adhesive 9.

The present invention is not limited to the above embodiments, various changes may be made within the scope indicated in the claims, and the embodiments obtained by the appropriate combination of technical means disclosed in different embodiments are also included in the technical scope of the present invention.

What is claimed is:

1. A roll material for making an anti-counterfeiting sealing film, comprising:
an adhesive sealing film; and
a lifting and pulling composite layer, located on the adhesive sealing film, and the lifting and pulling composite layer comprises an information layer, a backing layer, and a layer of functional film sequentially from top to bottom;
wherein, the layer of functional film has a PE film or an EPE film and a plurality of microbonding blocks sequentially from top to bottom, and the plurality of microbonding blocks is coated with a release coating.

2. The roll material according to claim 1, wherein the lifting and pulling composite layer has a tearing line that is formed through a continuous curve segment in coordination with a discontinuous curve segment.

3. The roll material according to claim 1, wherein the PE film or the EPE film further comprises a PET film thereon.

4. The roll material according to claim 1, wherein a material of the release coating is epoxy, silicone oil, varnish, or wax.

5. The roll material according to claim 1, wherein a surface of the release coating is glossy, matte, or dot matrix.

6. The roll material according to claim 1, wherein a main base material of the adhesive sealing film is EVA, PE, PP, or PET.

7. The roll material according to claim 1, wherein the information layer comprises a base film, an information chip, and an antenna layer sequentially from top to bottom.

8. The roll material according to claim 7, wherein the information chip is a radio frequency identification (RFID) chip, near-field communication (NFC) chip, electromagnetic identification (EMID) chip, long range identification (LoRaID) chip, or ultra-wideband identification (UWBID) chip.

9. The roll material according to claim 7, wherein a material of the base film is PET.

10. The roll material according to claim 1, wherein the backing layer comprises a PET film and a PE thick film sequentially from top to bottom.

11. The roll material according to claim 1, wherein a dry composite adhesive is disposed between each of the adhesive sealing film, the information layer, the backing layer, and the layer of functional film.

12. An anti-counterfeiting sealing film, comprising the roll material according to claim 1.

13. The anti-counterfeiting sealing film according to claim 12, wherein the anti-counterfeiting sealing film has a tearing line, and a plurality of breakpoints is formed on a path of the tearing line.
